(19) United States
(12) Patent Application Publication
(10) Pub. No.: US 2022/0232849 A1
(43) Pub. Date: Jul. 28, 2022

(54) REDUCED SUGAR CHOCOLATE AND METHOD OF MAKING THE SAME

(71) Applicant: The Hershey Company, Hershey, PA (US)

(72) Inventor: James F. St. John, Hummelstown, PA (US)

(73) Assignee: The Hershey Company, Hershey, PA (US)

(21) Appl. No.: 17/603,842

(22) PCT Filed: Apr. 22, 2020
(86) PCT No.: PCT/US2020/029320

§ 371 Date: Oct. 14, 2021

Related U.S. Application Data
(60) Provisional application No. 62/836,943, filed on Apr. 22, 2019.

(51) Int. Cl. A23G 1/40; A23G 1/46; A23G 1/36; A23G 1/38

(52) U.S. Cl. CPC A23G 1/40; A23G 1/46; A23V 2002/00; A23G 1/38; A23G 1/36

(57) ABSTRACT

A reduced sugar milk chocolate wherein at least a portion of the unsweetened chocolate used to make the product has been subjected to a debittering process that reduces the amount of caffeine and theobromine present. Use of the deflavored unsweetened chocolate enables non-fat cocoa to replace some of the sugar added to the chocolate without imparting an undesirable amount of bitterness or chocolate to flavor to the finished product. This composition and method also enables the production of a standard of identity chocolate with reduced sugar.

### BACKGROUND OF THE INVENTION

This invention relates generally to food product compositions, and more particularly to reduced sugar milk chocolate products having a higher percentage by weight of a cocoa solids component and/or a non-fat cocoa solids component, wherein the added sugar content is reduced by about 10-40% by weight. In addition, consumers would find the reduced sugar milk chocolate of the present invention to have taste and texture attributes of a typical milk chocolate. The present invention also relates generally to a process for producing a reduced sugar milk chocolate having a higher percentage by weight of a cocoa solids component and/or a non-fat cocoa solids component, wherein the added sugar content is reduced by about 10-40% by weight.

Consumer perceptions of sugar have resulted in some consumers desiring products containing reduced levels of added sugars in confections. Milk chocolates typically have approximately 50% or more by weight added sugar. While various sugar replacers have been introduced, they have been met with various levels of success.

Furthermore, milk chocolates with these sugar replacers do not meet the “Standard of Identity” (Sol) requirements in many countries. As a result, such confections cannot be labeled as “milk chocolate” in those countries because the sugar replacers are not allowed in standardized chocolates.

Some attempts have been made to overcome these problems. Many sugar replacers, such as sugar alcohols, dietary fibers, proteins, etc., have some type of drawback including high cost, the potential for gastrointestinal problems in some individuals, and/or flavor/textural deficiencies that make them less desirable.

Accordingly, there is a need for a reduced sugar milk chocolate that maintains the flavor and texture of a typical milk chocolate, contains ingredients within the Sol, does not generate gastrointestinal problems, is cost effective, and preferably delivers a reduced caloric content.

### SUMMARY OF THE INVENTION

Several specific aspects of the systems and methods of the present invention are outlined below.

Exemplary embodiments are directed to a reduced sugar milk chocolate that overcomes most or all of the foregoing, and other, challenges in the art. Formulations and processing methods provide a reduced sugar milk chocolate that contains a higher percentage by weight of a cocoa solids component and/or a non-fat cocoa solids component, that falls within the Sol, that has reduced added sugar content (and preferably also a lower fat and/or caloric content) compared to a typical milk chocolate, and that maintains a pleasing taste, texture and mouthfeel as a typical milk chocolate.

One embodiment is directed to a reduced sugar milk chocolate that contains a higher percentage by weight of a cocoa solids component and/or a non-fat cocoa solids component. In another embodiment, the cocoa solids component and/or non-fat cocoa solids component may be: (i) low in bitterness and/or low in chocolate flavor compared to a typical milk chocolate, or (ii) even lower in bitterness and even lower in chocolate flavor (or “highly dutched”) compared to (i). In yet another embodiment, the reduced sugar milk chocolate may contain one or more components for enhancing the sweetness of the reduced sugar milk chocolate.

Another embodiment is a method of making a reduced sugar milk chocolate.

Among the advantages of exemplary embodiments is a reduced sugar milk chocolate having the taste of a typical milk chocolate containing traditional levels of cocoa and sugar.

Another advantage is that exemplary embodiments only contain ingredients that fall within the Sol for milk chocolate.

Yet another advantage is that exemplary embodiments result in milk chocolates with a reduced added sugar content, and preferably with reduced fat content and the same or reduced caloric content as a typical milk chocolate.

Other features and advantages of the present invention will be apparent from the following more detailed description of exemplary embodiments that illustrate, by way of example, the principles of the invention.

### BRIEF DESCRIPTION OF THE DRAWINGS

The present invention will hereinafter be described in conjunction with the appended drawing figures.

FIG. 1 is a flow chart showing a first exemplary process for making a reduced sugar milk chocolate using deflavored cocoa solids;

FIG. 2 is a flow chart showing an exemplary method of processing raw nibs to produce deflavored unsweetened chocolate and deflavored cocoa powder;

FIG. 3 is a flow chart showing an exemplary method for producing a deflavored cocoa powder from cocoa powder;

FIG. 4 is a flow chart showing an exemplary method for producing highly dutched unsweetened chocolate using two extraction processes: (i) a “dutching” (alkalization) extraction process, and (ii) a water and/or alcohol extraction process (non-alkalization extraction);

FIG. 5 is a flow chart showing a first exemplary process for making a reduced sugar milk chocolate using highly dutched unsweetened chocolate;

FIG. 6 is a flow chart showing a second exemplary process for making a reduced sugar milk chocolate using highly dutched unsweetened chocolate;

FIG. 7 is a flow chart showing a third exemplary process for making a reduced sugar milk chocolate using highly dutched unsweetened chocolate;

FIG. 8 is a graphical representation of a Descriptive Panel Sensory Test performed on the examples described herein, showing levels of cocoa flavor, bitterness, and sourness in test samples of reduced sugar unsweetened chocolate and in control samples of a typical unsweetened chocolate; and

FIG. 9 is a chart of the results of a Descriptive Analysis Test, comparing a control sample with a 30% reduced sugar milk chocolate sample prepared in accordance with one of the examples described herein.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims.

Unless otherwise noted, all percentages provided in the specification and claims should mean percent by weight.

The term “milk chocolate”, as used in the specification and claims, is intended to refer to a milk chocolate having ingredients that fall within the “Standard of Identity” under Food and Drug Administration regulations (currently 21 CFR 163.130).

The term “reduced sugar milk chocolate”, as used in the specification and claims, is intended to refer to a milk chocolate having at least 25% less sugar by weight relative to a reference milk chocolate with a reference formulation. For purposes of this definition, sugar includes both added sugar and sugar that is contained in other ingredients, such as milk.

The term “cocoa bean” or “cacao bean”, as used in the specification and claims, is intended to refer to a cocoa bean that comes from pods harvested from the cacao tree and are the basis for chocolate components (unsweetened chocolate, cocoa butter, and cocoa powder).

Cocoa pods contain pulp and the cocoa bean. The cocoa bean is fermented and dried. The bean is winnowed to separate the shell from a “raw cocoa nib”. The raw cocoa nib may be subjected to extraction processes and/or roasted to generate a roasted cocoa nib.

The term “unsweetened chocolate” (or “chocolate liquor”), as used in the specification and claims, is intended to refer to a finely ground roasted cocoa nib, existing in a solid or semi-solid form. A typical unsweetened chocolate contains approximately 53% cocoa butter and approximately 47% non-fat cocoa solids.

The term “cocoa powder”, as used in the specification and claims, is intended to refer to a powder that is produced by pressing cocoa butter out of unsweetened chocolate. Under U.S. federal regulations, cocoa powder contains between 10% and 12% cocoa butter, “low fat cocoa powder” has less than 10% cocoa butter, and “non-fat cocoa powder” has less than 0.5% cocoa butter.

The term “cocoa butter”, as used in the specification and claims, is intended to refer to the fat obtained from a cocoa bean or nib.

The term “cocoa butter equivalent”, as used in the specification and claims, is intended to mean a composition comprising one or more non-lauric acid plant fats, including palm oil, shea butter, sal fat, illipe butter, and kukum butter. Cocoa butter equivalents are intended to resemble cocoa butter in both physical and chemical properties. A cocoa butter equivalent preferably has a melting point between 35 and 39 degrees C. and a melting profile (% of solid fat content vs. temperature) that is similar to cocoa butter (preferable ±5 degrees C. throughout the melting curve and, more preferably ±2 degrees C. throughout the melting curve).

The term “cocoa solids component”, as used in the specification and claims, means unsweetened chocolate, cocoa powder, or a mixture of unsweetened chocolate and cocoa powder.

The term “sugar”, as used in the specification and claims, is intended to refer to a carbohydrate sweetener that is added to a milk chocolate mixture and/or a reduced sugar milk chocolate composition. Sucrose is the most commonly used sugar in milk chocolate. Other examples of sugars commonly used in chocolate include lactose, glucose, and fructose.

The term “added sugar”, as used in the specification and claims, is intended to refer to sugars, such as sucrose and lactose, that are added to a chocolate mixture and does not include sugar that may be naturally present in other ingredients, such as milk ingredients.

The term “added cocoa butter”, as used in the specification and claims, is intended to refer to cocoa butter that is added to a chocolate mixture and does not include cocoa butter that is contained within another ingredient, such as unsweetened chocolate or cocoa powder.

The term “milk ingredient”, as used in the specification and claims, is intended to refer to a dairy product. Examples of milk ingredients include milk solids, cream, milk fat (including anhydrous milk fat), milk (which may be concentrated, sweetened condensed, evaporated, dried), skim milk (which may be concentrated, sweetened condensed, evaporated, dried, non-fat), or buttermilk (concentrated or dried).

The term “emulsifier”, as used in the specification and claims, is intended to refer to an ingredient that impacts fluidity of the chocolate. Examples of suitable emulsifiers may be any of those typically used in the art and include lecithin, polyglycerol polyricinoleate, ammonium phosphatide, or combinations thereof, by way of example only. The emulsifier is typically present at a maximum level of 1% of any one emulsifier or any mixture of emulsifiers, although more or less may be employed depending on the particular fat and emulsifier used.

The term “flavor”, as used in the specification and claims, is intended to refer to any natural flavorings, excluding those flavors which alone or in combination mimic milk flavors or chocolate flavors. Examples of suitable flavors include malt, fruits, berries, vanillin and ethylvanillin.

The term “methylxanthines”, as used in the specification and claims, is intended to refer to a class of compounds having a xanthine base, including caffeine and theobromine, that naturally occur in the cocoa bean.

The term “caffeine”, as used in the specification and claims, is intended to refer to a methylxanthine (1,3,7 trimethylxanthine).

The term “theobromine”, as used in the specification and claims, is intended to refer to a methylxanthine (3,7 dimethylxanthine).

The term “deflavored unsweetened chocolate”, as used in the specification and claims, means unsweetened chocolate having (a) less than 0.05% caffeine (more preferably less than 0.02% caffeine), (b) less than 0.5% theobromine (more preferably less than 0.2% theobromine), (c) that has been subjected to an extraction process, and (d) no portion of the extract produced during the extraction process is re-introduced. The preferred solvents for the extraction process are water, alcohol, or a mixture of water and alcohol.

The term “deflavored cocoa powder”, as used in the specification and claims, means cocoa powder having (a) less than 0.05% caffeine (more preferably less than 0.02% caffeine), (b) less than 0.5% theobromine (more preferably less than 0.2% theobromine), (c) that has been subjected to an extraction process, and (d) no portion of the extract produced during the extraction process is re-introduced. The preferred solvents for the extraction process are water, alcohol, or a mixture of water and alcohol.

The terms “deflavored cocoa solids” and “deflavored cocoa solids component” are synonymous and are intended to refer to deflavored unsweetened chocolate, deflavored cocoa powder, as well as mixtures of deflavored unsweetened chocolate and deflavored cocoa powder.

The term “high potency sweetener” (“HPS”), as used in the specification and claims, is intended to refer to a sweetener having a sweetness potency (by weight) that is at least fifty times, and more preferably at least 200 times, that of sucrose. Examples of HPS's include aspartame, cyclamates, saccharin, acesulfame, neohesperidin dihydrochalcone, sucralose, alitame, stevia sweeteners, glycyrrhizin, thaumatin and the like and mixtures thereof. Preferred high potency sweeteners are stevia extract (rebina), monk fruit extract aspartame, cyclamates, saccharin, and acesulfame-K.

The term “rare sugar”, as used in the specification and claims, is intended to refer to sugars that occur in very small quantities in nature. Examples include allulose, allose, melezitose, and tagatose.

The term “conching” means a process in which a chocolate mixture is mixed at a temperature of at least 40 degrees C. Purposes of conching including promoting the even distribution of cocoa butter and promoting the Maillard reaction. Preferably, conching is performed for at least six hours. Typically, the mixing comprises a scraping action which generates from friction at least some of the heat necessary to maintain the temperature.

The term “tempering” means a process in which a chocolate mixture is (a) heated to a temperature of between 110 and 120 degrees F., then (b) cooled to a temperature of between 78 and 82 degrees F., then optionally (c) reheated to a temperature between 88 and 92 degrees F. The cooling step results in the creation of crystals and the heating step melts the unstable crystals in the chocolate mixture while preserving the stable crystals. Optionally, chocolate seed (i.e., chocolate with crystals already formed) can be added during the cooling step.

A typical milk chocolate has about 4% to 8% by weight of non-fat cocoa solids. The bitterness of the non-fat cocoa solids is masked, in part, by the added sugar content within a typical milk chocolate. A reduced sugar milk chocolate having higher levels of full-flavor non-fat cocoa mass, for example 14% by weight of non-fat cocoa mass, and lower levels of sugar will be too bitter and too high in chocolate flavor. Exemplary embodiments include a reduced sugar milk chocolate having deflavored cocoa solids, which enable the finished product to maintain the ingredient restrictions of standardized chocolates and provide a pleasing taste that is not too bitter or too high in chocolate flavor.

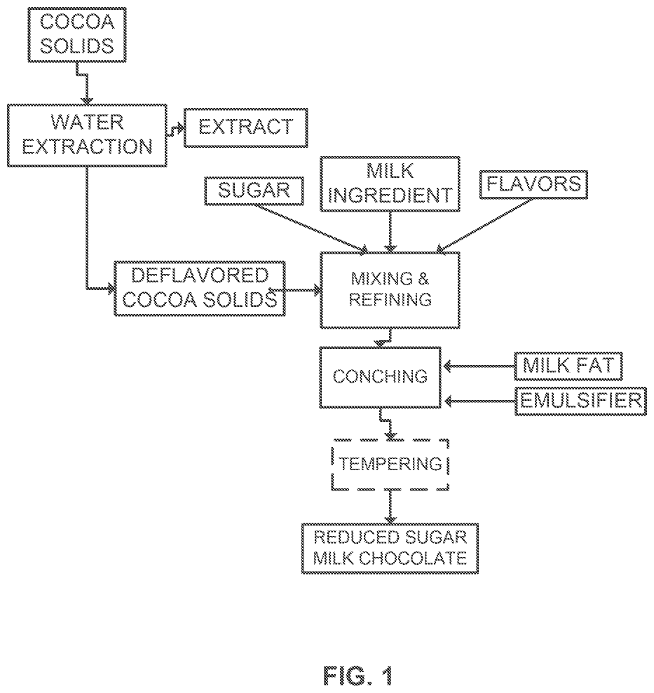

FIG. 1 shows an exemplary process for making reduced sugar milk chocolate. In this process, deflavored cocoa solids are mixed with at least one sugar, at least one milk ingredient, and additional flavors to form a chocolate mixture. The chocolate mixture is then conched to form a conched chocolate mixture. Milk fats and/or an emulsifier (such as lecithin) are optionally added during the conching step. The conched chocolate mixture is then tempered and cooled to form a reduced sugar milk chocolate tablet bar. If the product is intended for baking, then the tempering step can be omitted.

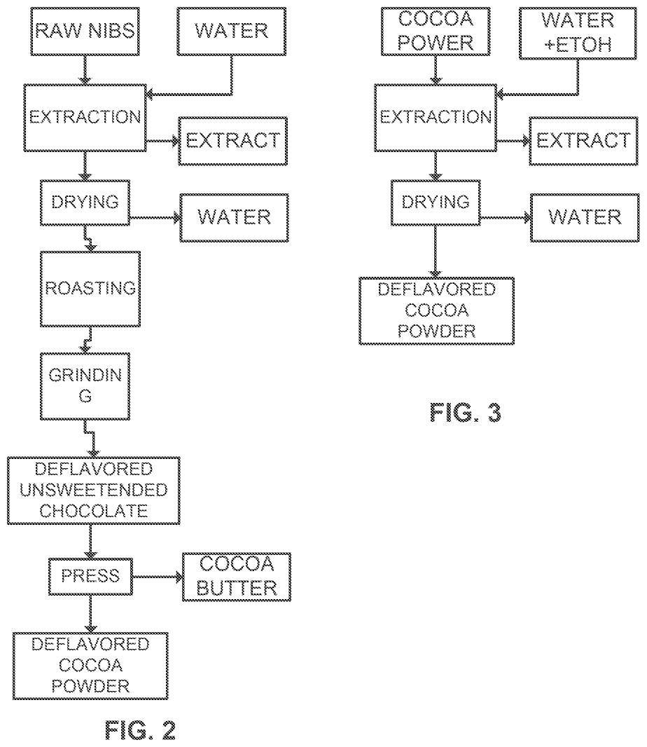

A first exemplary process for creating deflavored unsweetened chocolate or deflavored cocoa powder is shown in FIG. 2. Raw cocoa beans are winnowed to raw cocoa nibs and shells. The shells are discarded. The raw cocoa nibs are subjected to a series of extractions using water as the solvent. In this process, caffeine, theobromine, and other flavors are removed from the raw cocoa nibs by performing an extraction with water at 55 degrees C. and another extraction with water at 95 degrees C. to remove a majority of the caffeine and theobromine. This step in the process is similar to the teachings of U.S. Pat. No. 4,755,391, which is incorporated by reference as if fully set forth but does not require the degree of removal taught therein (99% of caffeine and theobromine). The extracts from this step contain methylxanthines, as well as the precursors for chocolate flavor development that occurs during the cocoa roasting step (chocolate flavor precursors). The precursors include all the sugars and some of the amino acids from the raw cocoa nib. In this exemplary process, the extracts are discarded and no portion of the extracts is re-introduced into the unsweetened chocolate. This is in contrast to U.S. Pat. No. 4,755,391, which teaches reintroduction of a part of the extract in order to enhance the chocolate flavor of the finished chocolate. The raw cocoa nibs are then dried, roasted, and ground into a deflavored unsweetened chocolate that is low in chocolate flavor and low in bitterness. Optionally, the deflavored unsweetened chocolate can be pressed to separate cocoa butter from the unsweetened chocolate and produce deflavored cocoa powder. In alternate embodiments, a different method for reducing bitterness and/or chocolate flavor from the raw cocoa nib, unsweetened chocolate and/or cocoa powder could be used such as using alcohol or an alcohol/water mixture as the solvent. In addition, the solvent could be an alkaline solution.

A second exemplary process for producing deflavored cocoa powder is shown in FIG. 3. In this embodiment, the deflavored cocoa is a by-product of a process used to extract flavor compounds from cocoa powder. The cocoa powder is subjected to an extraction process using water and preferably alcohol to extract caffeine, theobromine, sugar, and chocolate flavor. Flavors from the extract are separated, further processed, and sold as flavor compounds. As with the process shown in FIG. 1, no portion of the extracts is re-introduced into the deflavored cocoa powder. After extraction, the deflavored cocoa powder is discarded as waste. Immediately drying the extracted cocoa will result in deflavored cocoa with low caffeine and theobromine.

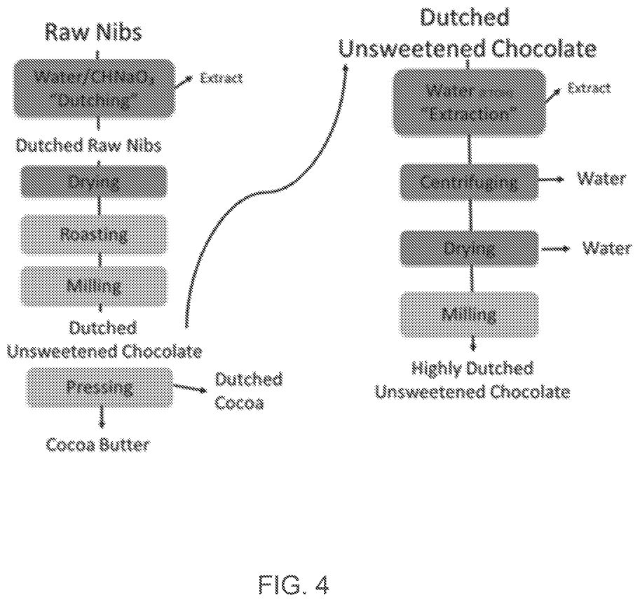

A third exemplary process for creating deflavored cocoa solids is shown in FIG. 4. In this exemplary process, the raw cocoa nib is subjected to an alkalization extraction process, also known as “dutching”, to reduce bitterness and flavor. In some embodiments, the raw cocoa nib is subjected to two extractions, a dutching and a non-alkalization extraction (like the extraction step shown in FIGS. 2 and 3). When both extractions are performed, the process is known as a “highly dutched” extraction.

As shown in FIG. 4, first, a raw cocoa nib is subjected to a dutching process to generate dutched raw nibs and an extract. As with the processes shown in FIGS. 2 and 3, no portion of the extract is re-introduced into the ditched raw nibs. The dutched raw nibs are then dried, roasted, and milled to make dutched unsweetened chocolate. Next, the dutched unsweetened chocolate is subjected to a process that is very similar to the process of FIG. 2, including a second extraction with water and/or alcohol. Several additional steps are then performed, including centrifuging, drying and milling, to generate a highly dutched unsweetened chocolate. In an alternate embodiment, a highly dutched extraction could be performed using concurrent dutching and a non-alkalization extraction. In addition, the second extraction process could be performed on the dutched cocoa power instead of the dutched unsweetened chocolate.

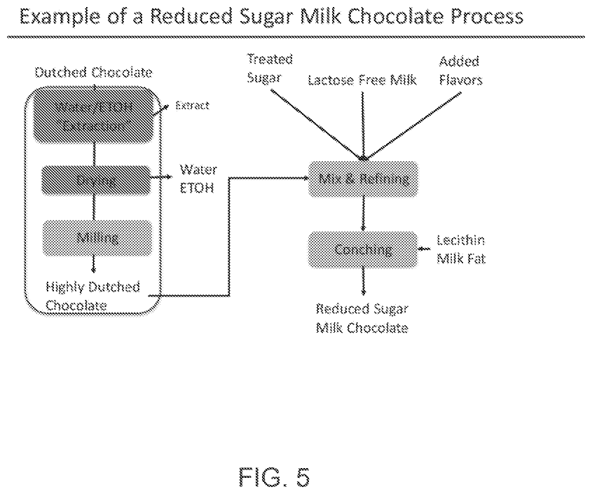

An exemplary embodiment of a reduced sugar milk chocolate made with a highly dutched unsweetened chocolate and at least one component to enhance the overall sweetness is shown in FIG. 5. In this embodiment, a first “highly dutched” extraction process (similar to that shown in FIG. 4) is performed. The highly dutched unsweetened chocolate is then mixed with sucrose and milk solids. Next, the ingredients are refined to decrease particle size and generate a paste. Then, the mixture undergoes conching, during which added cocoa butter, emulsifiers and flavors may be included. After tempering, the final reduced sugar milk chocolate product is finished.

Optionally, one or more components, such as treated sugar, lactose free milk and/or added flavors, may be added during the mixing or refining steps to enhance the overall sweetness. “Treated sugar” is sugar that has been processed to provide a reduced total surface area and rounded edges due to the process of mixing and grinding sugar with unsweetened chocolate, which is followed by a water addition step and a final water drying step. The reduced surface area of the treated sugar results in a slower rate of dissolving in the mouth and a prolonged sense of sweetness (as taught in U.S. Pat. No. 5,464,649). “Lactose free milk” or “enzymatically-treated milk” means milk that has been treated with lactase. Lactose has about 20% of the sweetness potency of sucrose. Typical milk chocolate contains approximately 4 to 11% lactose by weight. In lactase-treated milk, lactose is cleaved into two monosaccharides, glucose and galactose, which are much sweeter than lactose. Lactose free milk has the benefit of allowing for an increased sweetness, while maintaining Standard of Identity for milk chocolate. “Added flavors” include vanillin, sweetness enhancers, and/or bitterness inhibitors.

“Treated sugar” means sugar particles having a reduced total surface area and rounded edges due to the process of mixing and grinding sugar with unsweetened chocolate. Others have taught mixing and grinding sugar with cocoa butter with roll refiners. This method of particle size-reduction is problematic in the present invention because very little cocoa butter is added. In exemplary embodiments of the present invention, the sugar is mixed with unsweetened chocolate, then ground using a conventional chocolate roll refiner. Water is then added, then an emulsifier. The water is then dried off to produce sugar crystals with a lower total surface area. In typical milk chocolate, water processing could damage the chocolate flavor by stripping chocolate flavors with the evaporating moisture. The inventors have discovered that the high levels of unsweetened chocolate present in the reduced sugar milk chocolates described herein allow for water processing without damaging chocolate flavor.

Treated sugar co-crystallized with high potency sweeteners (HPS's) may optionally be included to further enhance the sweetness. HPS's are preferably added during the water addition step when making treated sugar. As the water is driven off in the drying step, the HPS's co-crystallize with the sugar. When adding treated sugar co-crystallized with HPS's, a much higher level of sweetness will be detected than if the HPS's and the treated sugar are added separately to the chocolate.

Preferably, at least one of the sweetness-enhancing components discussed above is performed as part of the process of making the reduced sugar milk chocolate. Such measures are preferred because, although less sugar is required to offset the bitterness and chocolate flavor of the deflavored cocoa solids than would be necessary with normal chocolate solids, the inventors have determined that some additional sweetness is desirable.

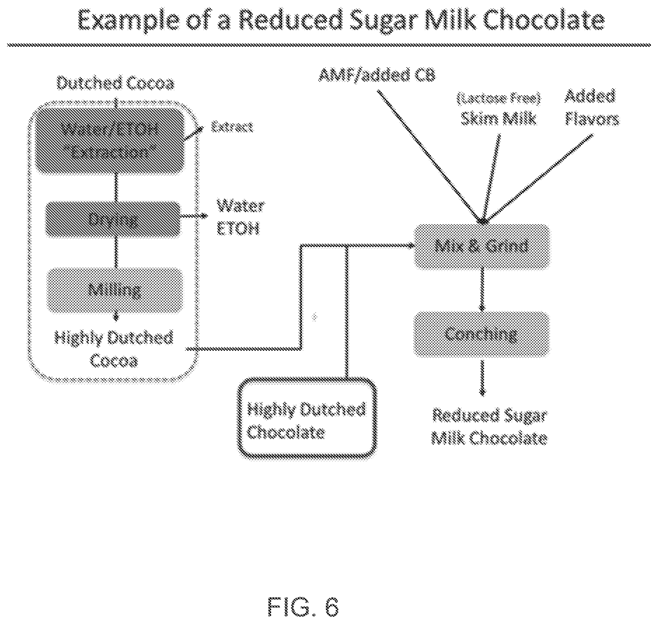

A third exemplary embodiment of a reduced sugar milk chocolate is made with a highly dutched unsweetened chocolate as shown in FIG. 6. The highly dutched cocoa powder is made by performing a non-alkalization extraction on dutched cocoa powder. The highly dutched cocoa powder and highly dutched unsweetened chocolate are mixed with sucrose and milk solids. The subsequent steps are nearly identical to those shown in FIG. 5 (and discussed above), except for the following: (1) different components may be added to enhance the sweetness (lactose free skim milk and/or added flavors) and (2) added cocoa butter and anhydrous milk fat are added in the mixing and refining stage.

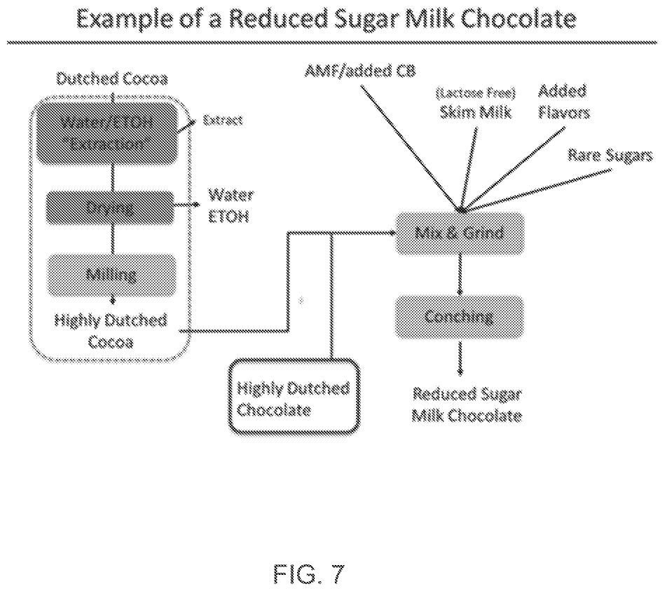

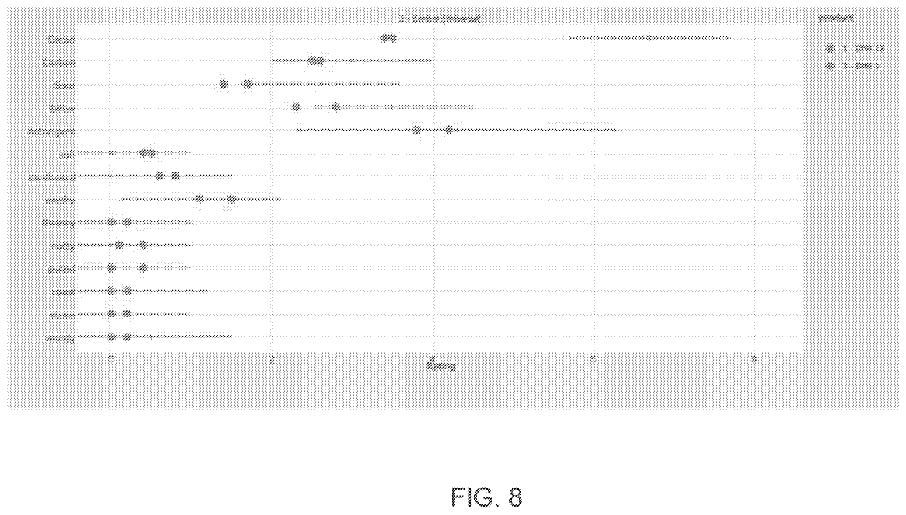

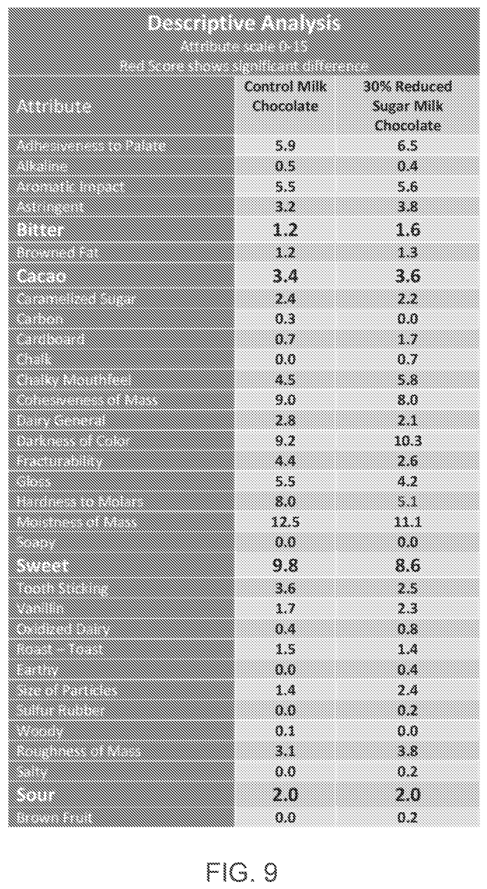

A fourth exemplary embodiment of a reduced sugar milk chocolate is made with a highly dutched unsweetened chocolate, a highly dutched cocoa powder, and at least one component to enhance the overall sweetness is shown in FIG. 7. This embodiment is nearly identical to the embodiment of FIG. 6, except that the optional sweetness enhancers also includes a rare sugar.

### EXAMPLES

The invention is further described in the context of the following examples which are presented by way of illustration, not of limitation.

### Example 1: A Low Bitterness and Low Flavor Unsweetened Chocolate

Raw cocoa beans are winnowed to nibs and shells. The shells are discarded. Similar to the method of U.S. Pat. No. 4,755,391, the raw nibs are subjected to a series of extractions, which remove chocolate flavor and bitterness from the raw nibs. First, the raw nibs undergo one extraction step with water at about 55 degrees C. Then, the raw nibs are subjected to one extraction step with water at about 95 degrees C. These two extraction steps are sufficient to remove a majority of theobromine and caffeine, as well as all the sugars and some of the amino acids (which are precursors for chocolate flavor development during the cocoa roasting step). The resulting raw cocoa nibs are dried, roasted and ground into unsweetened chocolate that is low in bitterness and low in chocolate flavor. Several low-flavor, low-bitterness unsweetened chocolate samples are prepared for testing.

A Descriptive Panel Sensory Test is used to measure the levels of cocoa flavor and bitterness of samples. A typical unsweetened chocolate with full flavor and full bitterness (control sample) is compared to two low-flavor, low-bitterness unsweetened chocolates, samples DMX3 and DMX14. As shown in FIG. 6, the cocoa flavor of DMX3 and DMX14 are rated at approximately 3.5, whereas the cocoa flavor of the control sample is rated at approximately 7. Similarly, the bitterness ratings of DMX3 and DMX14 are about 2, whereas the bitterness rating of the control is about 3.5. In addition, the sour rating of the two test samples are approximately 1.5, which is reduced compared to the control sample rating of 2.5.

Analytical Testing of theobromine and caffeine levels verifies the sensory test results and the extraction protocol. Table 1 compares DMX3 and DMX14 test samples to a control unsweetened chocolate (which is not been subjected to extraction). The data shows DMX3 and DMX14 have reduced caffeine and reduced theobromine levels compared to a typical unsweetened chocolate. Table 1 also compares a “finished” reduced sugar milk chocolate to a typical milk chocolate. (The “finished” reduced sugar milk chocolate is made with low-flavor, low-bitterness unsweetened chocolate, which is then mixed with sugar and milk before the refining/conching/tempering steps). The results in Table 1 indicate a “finished” reduced sugar milk chocolate has reduced caffeine and theobromine levels compared to typical milk chocolates. This data indicates the extraction process successfully removed a majority of caffeine and theobromine and also confirmed the sensory panel ratings, which show that DMX3 and DMX14 have reduced bitterness compared to a typical unsweetened chocolate control sample.

TABLE 1
Analytical Testing of Theobromine and Caffeine Levels

| | Caffeine | Theobromine |
|---|---|---|
| Sample | (% by weight) | (% by weight) |
| Control 1 - Unsweetened | 0.11% | 1.04% |
| Chocolate | | |
| DMX3 - Highly Dutched | 0.009% | 0.06% |
| Unsweetened Chocolate | | |
| DMX14 - Highly Dutched | 0.079% | 0.32% |
| Unsweetened Chocolate | | |
| Control 2 - Typical Milk | 0.011% | 0.10% |
| Chocolate | | |
| Control 3 - Typical Milk | 0.017% | 0.15% |
| Chocolate | | |
| “Finished” Reduced Sugar | 0.005% | 0.03% |
| Milk Chocolates | | |

### Example 2: A 20% Reduced Sugar SOI Milk Chocolate with an American Style Flavor (Strong Chocolate Flavor)

An exemplary 20% reduced sugar SOI milk chocolate is prepared using highly dutched unsweetened chocolate. FIG. 2 shows the method for preparing the highly dutched unsweetened chocolate. Next, additional ingredients and sweetener components are added as follows. First, sugar and highly dutched unsweetened chocolate are mixed. Then, the sugar is ground with highly dutched unsweetened chocolate on a chocolate roll refiner. Next, deionized water and a small amount of high potency sweeteners (HPSs) are added to the mixture while mixing. Within 10 minutes, lecithin is added and the treated sugar-HPS/dutched chocolate/lecithin mixture is continuously mixed until the water is removed, which results in a paste labeled “treated sugar with co-crystallized HPS's”. Next, the whole milk powder treated with lactase is made by treating the milk powder with the enzyme, lactase. Then, the following ingredients are mixed, refined and added to the “treated sugar with co-crystallized HPS's paste: whole milk powder treated with lactase, added cocoa butter, and flavors/added flavors (sweetness enhancers, bitterness inhibitors, and/or additional vanillin). These ingredients are mixed together into a final mixture. The final mixture is conched to produce a 20% reduced sugar milk chocolate.

According to the formulation listed in Table 2, 20% by weight of the added sugar (and 10% by weight of the total composition) in a typical milk chocolate is replaced by a highly dutched unsweetened chocolate. The total percent of non-fat cocoa in the reduced sugar milk chocolate is 17.16% by weight, which is double the level measured in the control milk chocolate (7.52% by weight).

TABLE 2
A 20% Reduced Sugar SOI Milk Chocolate Formulation

| | Typical Milk Chocolate | | | 20% Reduced Sugar Milk Chocolate | | |
|---|---|---|---|---|---|---|
| | | | % Non-Fat | | | % Non-Fat |
| Ingredient | Formulation | Sugar | Cocoa | Formulation | Sugar | Cocoa |
| Sugar | 47.00% | 47.00% | | | | |
| Treated | | | | 37.50% | 37.50% | |
| Sugar with co- | | | | | | |
| crystallized | | | | | | |
| HPSs | | | | | | |
| Added | 16.00% | | | 5.36% | | |
| Cocoa | | | | | | |
| Butter | | | | | | |
| Highly | | | | 36.50% | | 17.16% |
| Dutched | | | | | | |
| Unsweetened | | | | | | |
| Chocolate | | | | | | |
| Unsweetened | 16.00% | 0.16% | 7.52% | | | |
| Chocolate | | | | | | |
| Whole Milk | 20.00% | 7.00% | | | | |
| Powder | | | | | | |
| Whole Milk | | | | 20.00% | 7.00% | |
| Powder | | | | | | |
| treated with | | | | | | |
| Lactase | | | | | | |
| Lactose | 0.80% | 0.80% | | | | |
| MilkFat | 0% | | | 0% | | |
| Lecithin | 0.18% | 0.00% | | 0.30% | 0.00% | |
| Natural | | | | 0.30% | | |
| Flavors | | | | | | |
| Vanillin | 0.02% | | | 0.04% | | |
| | 100.00% | 54.96% | 7.52% | 100.00% | 44.50% | 17.16% |

Based on analytical testing, the 20% reduced sugar milk chocolate has a caffeine level of 0,014% by weight and a theobromine level of 0.03% by weight, which results in a significant reduction in bitterness and flavor content.

### Example 3: A 30% Reduced Sugar SOI Milk Chocolate with a European Style Flavor

An exemplary 30% reduced sugar milk chocolate composition is prepared using highly dutched unsweetened chocolate and highly dutched cocoa powder, both of which are made in a manner similar to the methods previously discussed and shown in FIGS. 2 and 4. Additional ingredients and sweetener components are added as follows. Sucrose is mixed and ground with the highly dutched unsweetened chocolate, highly dutched cocoa powder, skim milk treated with lactase, and flavors/added flavors (sweetness enhancers, bitterness inhibitors and/or addition vanillin) to form a highly dutched chocolate mixture. The highly dutched chocolate mixture is refined and then conched with added cocoa butter, anhydrous milk fat and lecithin. According to the formula listed in Table 3, 30% by weight of the added sugar (and about 16.5% by weight of the total composition) in a typical milk chocolate is replaced by the highly dutched unsweetened chocolate and highly dutched cocoa powder. The total percent of non-fat cocoa in the exemplary composition is about 20.2% by weight, which is approximately four times higher than the control milk chocolate.

TABLE 3
A 30% Reduced Sugar Milk Chocolate Formulation

| | Typical Milk Chocolate | | | | 30% Reduced Sugar Milk Chocolate | | | |
|---|---|---|---|---|---|---|---|---|
| | | | % Non-Fat | % Total | | | % Non-Fat | % Total |
| Ingredient | Formulation | Sugar | Cocoa | Cocoa | Formulation | Sugar | Cocoa | Cocoa |
| Sucrose | 45.10% | 45.10% | | | 28.38% | 28.38% | | |
| Added | 17.40% | | | 17.40% | 5.00% | | | 5.00% |
| Cocoa | | | | | | | | |
| Butter | | | | | | | | |
| Highly | | | | | 8.00% | | 7.04% | 8.00% |
| Dutched | | | | | | | | |
| Cocoa | | | | | | | | |
| Powder | | | | | | | | |
| Highly | | | | | 33.00% | | 13.20% | 33.00% |
| Dutched | | | | | | | | |
| Unsweetened | | | | | | | | |
| Chocolate | | | | | | | | |
| Unsweetened | 11.88% | | 5.58% | 11.88% | | | | |
| Chocolate | | | | | | | | |
| Skim Milk | 20.00% | 11.00% | | | | | | |
| Skim Milk | | | | | 20.00% | 11.00% | | |
| Treated with | | | | | | | | |
| Lactase | | | | | | | | |
| Anhydrous | 5.30% | | | | 5.30% | | | |
| MilkFat | | | | | | | | |
| Lecithin | 0.30% | | | | 0.30% | | | |
| Vanillin | 0.02% | | | | 0.02% | | | |
| | 100.00% | 56.10% | 5.58% | 29.28% | 100.00% | 39.38% | 20.24% | 46.00% |

Analytical testing showed the composition had a caffeine level of 0.017% by weight and a theobromine level of 0.03% by weight, indicating the bitterness and flavor content were reduced. In addition, the caloric content of the 30% reduced sugar milk chocolate was 190 calories in a 40 gram serving compared to 205 calories for a 40 gram serving of a typical milk chocolate.

As shown in FIG. 7, a Descriptive Analysis measures thirty-three flavor, texture and visual attributes. The scores from the 30% reduced sugar composition show that only texture significantly differed from control attributes. The flavor attribute did not differ significantly.

Four additional attributes are notable in FIG. 7: bitter, cacao, sour and sweet attributes. First, the non-fat cacao level of the reduced sugar milk chocolate is almost four times higher than control, so the bitter, cacao and sour scores from the 30% reduced sugar composition are expected to be significantly higher than control. Next, the exemplary composition has 30% by weight less added sugar and 40% by weight less sucrose than control, yet the composition was only slightly less sweet than control. Therefore, consumers would find the 30% reduced sugar milk chocolate to be a typical milk chocolate containing traditional levels of cacao and sugar.

### Example 4: A 30% Reduced Sugar SOI Milk Chocolate with a European Style Flavor and a Rare Sugar

Another exemplary 30% reduced sugar milk chocolate composition is prepared using highly dutched unsweetened chocolate and a highly clutched cocoa powder. The 30% reduced sugar milk chocolate is made as follows. Instead of having 28.4% sucrose, as in Example 3, the added sugar is split between sucrose and tagatose, a rare sugar. The two types of sugar are mixed and ground with the highly dutched unsweetened chocolate, highly clutched cocoa powder, skim milk treated with lactase, and the flavors/added flavors (sweetness enhancers, bitterness inhibitors and/or added vanillin) to produce a ground mixture. The ground mixture is conched with added cocoa butter, anhydrous milk fat and lecithin.

According to the formula listed in Table 4 in which 30% by weight of the added sugar (and about 16.5% by weight of the total composition) in a typical milk chocolate is replaced by a highly dutched chocolate and a highly dutched cocoa powder. The total percent of non-fat cocoa in the composition is about 20.2% by weight, which is approximately four times higher than the control.

TABLE 4
A 30% Reduced Sugar Milk Chocolate (with Tagatose) Formulation

| | Typical Milk Chocolate | | | | 30% Reduced Sugar Milk Chocolate | | | |
|---|---|---|---|---|---|---|---|---|
| | | | % Non-Fat | % Total | | | % Non-Fat | % Total |
| Ingredient | Formulation | Sugar | Cocoa | Cocoa | Formulation | Sugar | Cocoa | Cocoa |
| Sucrose | 45.10% | 45.10% | | | 14.19% | 14.19% | | |
| Rare Sugar | | | | | 14.19% | 14.19% | | |
| Added | 17.40% | | | 17.40% | 5.00% | | | 5.00% |
| Cocoa | | | | | | | | |
| Butter | | | | | | | | |
| Highly | | | | | 8.00% | | 7.04% | 8.00% |
| Dutched | | | | | | | | |
| Cocoa | | | | | | | | |
| Powder | | | | | | | | |
| Highly | | | | | 33.00% | | 13.20% | 33.00% |
| Dutched | | | | | | | | |
| Unsweetened | | | | | | | | |
| Chocolate | | | | | | | | |
| Unsweetened | 11.88% | | 5.58% | 11.88% | | | | |
| Chocolate | | | | | | | | |
| Skim Milk | 20.00% | 11.00% | | | | | | |
| Skim Milk | | | | | 20.00% | 11.00% | | |
| Treated with | | | | | | | | |
| Lactase | | | | | | | | |
| Anhydrous | 5.30% | | | | 5.30% | | | |
| MilkFat | | | | | | | | |
| Lecithin | 0.30% | | | | 0.30% | | | |
| Vanillin | 0.02% | | | | 0.02% | | | |
| | 100.00% | 56.10% | 5.58% | 29.28% | 100.00% | 39.38% | 20.24% | 46.00% |

Analytical testing shows the composition has a caffeine level of 0.017% by weight and a theobromine level of 0.03% by weight indicating the bitterness and flavor content were significantly reduced. Therefore, the low-flavor, low-bitterness unsweetened chocolate may be used to make a 30% reduced sugar milk chocolate confection without delivering unacceptable levels of bitterness and cacao flavors. In addition, the caloric content of the 30% reduced sugar milk chocolate is reduced to 170 calories in a 40 gram serving, compared to 205 calories for a 40 gram serving of a typical milk chocolate.

While the principles of the invention have been described above in connection with preferred embodiments, it is to be clearly understood that this description is made only by way of example and not as a limitation of the scope of the invention.

1. A chocolate confection comprising:
at least one sweetener selected from the group consisting of added sugar, at least one high potency sweetener, and at least one rare sugar, the added sugar comprising no more than 40% of the chocolate confection;
a cocoa solids component comprising at least 50% deflavored cocoa solids, the cocoa solids comprising at least 20% of the chocolate confection;
at least one milk ingredient, the at least one milk ingredient comprising between 12 and 20% of the chocolate confection; and
at least one ingredient selected from the group of added cocoa butter and added cocoa butter equivalents.

2. The chocolate confection of claim 1, wherein the chocolate confection is milk chocolate.

3. The chocolate confection of claim 1, wherein at least one selected from the group of added cocoa butter and added cocoa butter equivalents comprises no more than 12% of the chocolate confection.

4. The chocolate confection of claim 1, wherein at least one selected from the group of added cocoa butter and added cocoa butter equivalents comprises cocoa butter.

5. The chocolate confection of claim 1, wherein at least one selected from the group of added cocoa butter and added cocoa butter equivalents comprises cocoa butter equivalents.

6. The chocolate confection of claim 1, wherein the cocoa solids component comprises at least 80% deflavored cocoa solids.

7. The chocolate confection of claim 1, wherein the cocoa solids component consists of deflavored cocoa solids.

8. The chocolate confection of claim 1, wherein the cocoa solids component comprises at least 30% of the chocolate confection.

9. The chocolate confection of claim 1, wherein the deflavored cocoa solids consist of deflavored cocoa powder.

10. The chocolate confection of claim 1, wherein the deflavored cocoa solids consist of dutched deflavored cocoa powder.

11. The chocolate confection of claim 1, wherein the deflavored cocoa solids consist of highly dutched deflavored cocoa powder.

12. The chocolate confection of claim 1, wherein the deflavored cocoa solids consist of deflavored unsweetened cholate.

13. The chocolate confection of claim 1, wherein the deflavored cocoa solids consist of dutched deflavored unsweetened cholate.

14. The chocolate confection of claim 1, wherein the deflavored cocoa solids consist of highly dutched deflavored unsweetened cholate.

15. The chocolate confection of claim 1, wherein the deflavored cocoa solids consist of a mixture of deflavored cocoa powder and deflavored unsweetened chocolate.

16. The chocolate confection of claim 1, wherein the at least one milk ingredient comprises at least 50% enzymatically-treated milk.

17. The chocolate confection of claim 1, further comprising at least one sweetness enhancing component.

18. The chocolate confection of claim 1, wherein the at least one sweetener consists of added sugar.

19. The chocolate confection of claim 1, wherein the at least one sweetener comprises added sugar, wherein the added sugar consists of treated sugar.

20. The chocolate confection of any of claim 1, wherein the at least one sweetener comprises treated sugar that has been co-crystalized with a high-potency sweetener.

21.-29. (canceled)
